(19) United States
(12) Patent Application Publication
(10) Pub. No.: US 2026/0217926 A1
(43) Pub. Date: Jul. 30, 2026

(54) PROCESS FOR PRODUCING A SINGLE-MATERIAL PARTICLE-FOAM COMPONENT

(71) Applicant: Evonik Operations GmbH, Essen (DE)

(72) Inventors: Florian Hopf, Neu Isenburg (DE); Christian Traßl, Warmensteinach (DE); Denis Holleyn, Nentershausen (DE)

(73) Assignee: Evonik Operations GmbH, Essen (DE)

(21) Appl. No.: 19/145,220

(22) PCT Filed: Dec. 22, 2023
(86) PCT No.: PCT/EP2023/087646

§ 371 Date: Jul. 2, 2025

(30) Foreign Application Priority Data
Jan. 6, 2023 (EP) 23150563.7

(51) Int. Cl. C08J 5/12; B29C 44/02; B29C 44/56; B29K 79/00; B29K 105/04

(52) U.S. Cl. CPC C08J 5/122; B29C 44/02; B29C 44/56; B29K 2079/085; B29K 2105/04; C08J 2379/08

(57) ABSTRACT

The present invention relates to a process for producing single-material particle-foam components based on thermoplastic base polymers, characterized in that a foamable base polymer is processed with a modified base polymer into a single-material particle-foam component.

### FIELD OF THE INVENTION

The present invention relates to a process for producing a single-material particle-foam component based on thermoplastic base polymers, characterized in that a foamable base polymer is processed with a modified base polymer into a single-material particle-foam component.

### PRIOR ART

The increasing use of lightweight construction materials is leading to the rapid further development of this technology. In addition to the search for suitable materials and by the production process, new areas of application are increasingly also being developed.

The use of polymer foams has moved into the spotlight here. Foam materials suitable for fittings in the aviation industry are well known. It is mostly foams composed of pure PMI (polymethacrylimide), PPSU (polyphenylene sulfones) or PES (polyether sulfones) that have been described. Also described in the literature is PARI (polyarylamide), but this is unsuitable from a toxicological viewpoint. All these materials have thus far been used predominantly as block or slab materials.

Polymer foams based on polyetherimides (PEI) meet the legal requirements for aircraft interiors laid down by the aviation industry. Specifically, the requirements concerning fire behaviour, stability to media and mechanical properties represent a great challenge here.

Depending on the application, the polymer foams are provided with cover layers, inserts, fastening elements, etc. In the aviation industry in particular, special requirements as regards their durable strength, resilience or non-destructive dismantling are placed on these elements. Drawbacks of the joining techniques known from the prior art, such as gluing, welding or riveting, are that these joining methods are difficult to monitor, have only a limited degree of process reliability and involve a great deal of work in the preparation and finishing of the joins.

Material joins are effected through adhesive and cohesive forces. These are non-detachable joins that can be separated only by destroying the joining means. The best-known material-joining processes are soldering, welding and gluing.

One modern process describes the use of plastic bosses, for example in hollow-chamber structures. These can be used as a screw boss or direct joining element. Depending on the design, these can be detachable or non-detachable joins. The joining element is placed on the component to be joined and subjected to a defined rotational speed and force so that the top layer heats up. This results in the top layer rubbing off. The melted joining element penetrates into the component and flows into the hollow chambers of the intermediate layer. This gives rise to undercuts that create a form-fitting join.

This joining technology is used in automotive engineering when tools are accessible only from one side during screwing or are to be processed only from one side for aesthetic reasons.

Processes for producing foams from expandable granules are known to those skilled in the art. Such granules are typically blowing-agent-containing particles of a thermoplastic material that are heated, for example with steam, to volatilize the blowing agent. The discharge of the blowing agent results in expansion of the particles to form a predominantly closed-cell foam. These foams-often at elevated temperature-then press against one another by the particle expansion that occurs, with the result that the individual particles acquire a certain adhesion to one another.

The foams are optionally reinforced with fabric layers or with materials and provided with inserts, in order to anchor them firmly, for example. The inserts are usually made of metal or plastic. The choice of inserts usually depends on the task they have to fulfil and the mechanical requirements, and also economic aspects. This is how materials are usually mixed. For example, PEI foam blocks are provided with metal inserts.

What all prior art processes have in common is the mix of plastic and metal materials or of other materials. This mix of materials makes recycling very difficult, which is accordingly not usually carried out.

Single-material systems consisting of foam and compact elements cannot be materially joined in the process, because the thermal processing windows are not compatible.

The use of adhesives that this necessitates in turn has an adverse effect on the weight properties of the moulded part.

WO 2017/109079 A1 relates to a method for producing a molded body from a particle foam material in a closable mold cavity of a molding tool, which comprises introducing the particle foam material in the form of granulate into the mold cavity of the molding tool, closing the mold cavity, and heating the molding tool and the granulate contained therein, whereby the particles of the granulate are connected together.

### OBJECT OF THE INVENTION

The object of the present invention was to overcome or at least minimize the disadvantages of the known prior art processes.

For recycling, a mix of materials should be avoided. The corresponding single-material systems would join foam parts with unfoamed joining elements.

Against the background of the discussed prior art, it was an object of the present invention in particular to provide a process for producing components made of high-temperature (HT) foams that is simpler and more effective by comparison with the prior art, allowing foam components to be materially joined with unfoamed joining elements.

### SUMMARY OF THE INVENTION

The problems detailed above can be solved by specifically lowering the glass transition temperature of the compact component to the level of the processing temperature of the foam. This allows a material join to be realized in a single-material system.

The object was achieved more particularly by a process for producing a single-material particle-foam component based on thermoplastic base polymers, characterized in that a foamable base polymer is processed with a modified base polymer into a single-material particle-foam component. The process of the invention comprises the process steps a), b), c), d), e) and f). These are carried out in the order specified. In addition, the process of the invention optionally includes a process step g). The optional process step g) is carried out after process step f).

Embodiments and preferences that are described herein and in the claims can be combined with one another without restriction provided this is not explicitly excluded or technically impossible. Where the term “at least one” is used in the claims or the description, this signifies the choice of “one” and “more than one”.

### The Process of the Invention Comprises the Steps of:

a) providing a foamable base polymer, which has optionally already been prefoamed,
b) providing a modified base polymer,
c) supplying the modified base polymer to the processing operation and supplying the foamable base polymer, which has optionally already been prefoamed,
d) setting the processing temperature TP by the supply of energy and
e) creating a material join between the foamed base polymer and the modified base polymer,
f) removing the single-material particle-foam component obtained,
g) optionally, heat-treating the single-component particle-foam component obtained.

It was found that the specific modification of the base polymer to a glass transition temperature Tg_{base polymer modified} below the glass transition temperature of the base polymer Tg_{base polymer}, measured by DSC in accordance with DIN EN ISO 11357-2 (published: 2014-07), makes it possible to produce a single-material particle-foam component.

Surprisingly, it was found that the base polymer can be processed into a modified base polymer by adding at least one solvent, blowing agent or plasticizer. Accordingly, modification of the thermoplastic base polymer to produce a modified base polymer can be effected by adding at least one solvent, blowing agent or plasticizer to the thermoplastic base polymer. In particular, it was found that the thermoplastic base polymer can be processed into a modified base polymer, wherein the modified base polymer has a glass transition temperature Tg_{base polymer modified} below the glass transition temperature of the base polymer Tg_{base polymer}, by adding at least one solvent, blowing agent or plasticizer. Accordingly, modification of the thermoplastic base polymer to produce a modified base polymer having a glass transition temperature Tg_{base polymer modified} below the glass transition temperature of the base polymer Tg_{base polymer} can be in particular effected by adding at least one solvent, blowing agent or plasticizer to the thermoplastic base polymer. Other substances that lower the Tg of the base polymer can also be used to modify the base polymer.

Particle foams containing blowing agent, such as for example residual blowing agent, have a lower glass transition temperature than the compact polymer without blowing agents.

The single-material particle foam component according to the invention is a combination of a foamable base polymer with a modified base polymer. Herein, the modified base polymer may be obtained by treating the base polymer with a solvent, a blowing agent or a plasticizer, such as for example by spraying, dipping, wetting or mixing. Such treatment with a solvent, blowing agent or plasticizer results in a decrease of the glass transition temperature of the base polymer. Accordingly, the modified base polymer is obtainable or being obtained by such treatment. By the subsequent processing of the modified base polymer with the foamable base polymer the single-material particle-foam component is formed via material join.

### Process Step a)

In process step a) of the process of the invention, a foamable base polymer is provided. The foamable base polymer is produced from a thermoplastic base polymer by adding a blowing agent. Preference is given to using a thermoplastic base material having a glass transition temperature of at least 100° C., more preferably above 150° C., most preferably above 180° C., measured by DSC in accordance with DIN EN ISO 11357-2 (published: 2014-07).

The thermoplastic base polymer is selected from the group consisting of polyimide, polyketone and polyacrylate, preferably polymethacrylimide (PMI), polyetheretherketone (PEEK), polyetherimide (PEI), polymethyl (meth)acrylate (PM(M)A), polyethylene terephthalate (PET), polysulfone (PSU), polyethersulfone (PESU), polyphenylenesulfone (PPSU), polyamide (PA) or mixtures thereof.

Preference is given to using a blowing agent selected from the group consisting of volatile organic compounds having a boiling point at standard pressure below the glass transition temperature of the base polymer, inorganic blowing agents, thermally decomposable blowing agents and mixtures thereof. The at least one blowing agent is preferably a volatile organic compound having a boiling point at standard pressure below the glass transition temperature of the base polymer.

The volatile organic compound that has a boiling point at standard pressure below the glass transition temperature of the base polymer and is liquid at standard temperature (for example 25° C., 1013 mbar) is preferably selected from the group consisting of non-halogenated hydrocarbons, ketones, alcohols, urea, halogenated hydrocarbons and mixtures thereof.

The ketone is preferably selected from acetone, methyl ethyl ketone, cyclohexanone, cyclononanone, diacetone alcohol and mixtures thereof. The ketone is more preferably selected from acetone, methyl ethyl ketone and mixtures thereof.

The non-halogenated hydrocarbon preferably contains 4 to 8 carbon atoms. The non-halogenated hydrocarbon is more preferably selected from pentane, hexane and mixtures thereof.

The alcohol is preferably selected from methanol, ethanol, isopropanol, n-propanol and mixtures thereof.

The ester is preferably selected from the group consisting of methyl acetate, ethyl acetate, butyl acetate, and mixtures thereof.

The halogenated hydrocarbon is preferably selected from the group consisting of methyl chloride, ethyl chloride, dichloromethane, dichloroethane, dichlorodifluoromethane, dichlorotetrafluoroethane, trichlorofluoromethane, trichlorotrifluoroethane and mixtures thereof.

When the at least one blowing agent is an inorganic blowing agent, it is preferably selected from carbon dioxide, argon and mixtures thereof.

When the at least one blowing agent is a thermally decomposable blowing agent, it is preferably selected from azodicarbonamide, p-toluenesulfonyl semicarbazide, 5-phenyltetrazole and mixtures thereof. The thermally decomposable blowing agent has a decomposition temperature above which it releases a gas, thereby enabling the expansion of the base particle.

A foam particle is understood as meaning the region in a particle foam that is defined by the foaming of an individual unfoamed or prefoamed particle. The boundary between the individual, interconnected foam particles can be easily seen with the naked eye or determined under a light microscope. This applies in particular when the interfaces between two foam particles are clearly discernible. However, since this is not necessarily always the case, a simplified method is according to the invention used: a theoretical average diameter of a foam particle is simply calculated from the diameter of the unfoamed particles, the total volume of the unfoamed particles and the volume of the finished foam part. Those skilled in the art are aware that in particle foams it is possible to achieve a regular size distribution in the foam particles such that minor deviations occur only in the edge regions of the foam part.

Stated glass transition temperatures are according to the invention unless otherwise specified measured by DSC (differential scanning calorimetry), more particularly DSC in accordance with DIN EN ISO 11357-2 (published: 2014-07). Those skilled in the art are aware that DSC is sufficiently informative only when, after a first heating cycle up to a temperature that is a minimum of 25° C. above the highest glass transition temperature or melting temperature but at least 20° C. below the lowest decomposition temperature of a material, the material sample is held at this temperature for at least 2 min. The sample is then cooled again to a temperature at least 20° C. below the lowest glass transition temperature or melting temperature to be determined, for which the cooling rate should be not more than 20° C./min, preferably not more than 10° C./min. After a further wait time of a few minutes, the actual measurement is then carried out, in which the sample is heated to at least 20° C. above the highest melting temperature or glass transition temperature at a heating rate of normally 10° C./min or less.

It is preferable that the foams of the invention have a degree of foaming equating to a reduction in density compared to the unfoamed material of between 1% and 98%, preferably between 50% and 97%, more preferably between 70% and 95%. The foam has a density preferably between 20 and 1000 kg/m³, preferably 40 and 250 kg/m³, more preferably between 50 and 150 kg/m³.

The base polymers typically (on average) have a blowing agent content of 1% to 20% by weight, preferably 3% to 18% by weight, more preferably 7% to 16% by weight, based on the total composition.

Those skilled in the art are aware of suitable processes for producing particle foams (for example EP 3673009). These known processes afford granules laden with blowing agent (foamable base polymers).

These foamable base polymers can optionally be prefoamed.

The input of energy required for prefoaming can occur by means of contact heat, for example in a convection oven, by means of steam or through irradiation with IR or microwave radiation. The prefoamed base polymers still contain 0.5% to 12% by weight of blowing agent.

This process affords foamable base polymers, optionally prefoamed foamable base polymers, that may subsequently be foamed to the desired density by a renewed supply of energy and/or be processed further into a particle foam workpiece by optional shaping.

### Process Step b)

In process step b) of the process of the invention, a modified base polymer is provided. The process of the invention is characterized in that the modification of the base polymer to produce a modified base polymer is effected by adding solvents, blowing agents, plasticizers or other substances that lower the Tg of the base polymer, such as for example by spraying, dipping, steam-treatment, wetting or mixing with solvents, blowing agents, plasticizers or other substances that lower the Tg of the base polymer.

Preference is given to using a blowing agent as solvent.

Broad fields of application arise when the modified base polymer is available as a semifinished product. Examples include plates, panels, blocks, round bars, hollow bars, tubes, hoses, but also rods and profiles. Optionally, it is however also possible to use semifinished products that have been processed further. Inserts, plastic carriers and joining elements such as screws, hooks, eyelets, springs, clamps and other joining elements can in particular be used as modified base polymers (compact materials).

The base polymer, also referred to here as compact material, is contacted with the blowing agent, solvent or plasticizer above the melting temperature of the solvent for 1 s to 80 h. This results in modification of the compact material, preferably modification of the surface of the compact material. The modification is manifested in the lowering of the glass transition temperature Tg, especially at the surface. The modified base polymer thus obtained has a glass transition temperature Tg_{base polymer modified}. This is again measured by DSC in accordance with DIN EN ISO 11357-2 (published: 2014-07).

Ideally, the glass transition temperature is lowered only at the surface of the compact material. For optimal processing, the glass transition temperature of the modified base polymer is lowered to at least the processing temperature of the foamable base polymer TP.

The modified base polymer has a glass transition temperature Tg_{base polymer modified} below the glass transition temperature of the base polymer Tg_{base polymer}, measured by DSC in accordance with DIN EN ISO 11357-2 (published: 2014-07).

### Process Step c)

Process step c) of the process of the invention comprises the supplying of the modified base polymer to the processing operation and the supplying of the foamable base polymer, which has optionally already been prefoamed.

The modified base polymer (compact material) is available in any geometry.

These modified base polymers can be added loose to the processing operation; in a preferred variant they can be inserted into a shaping tool. Preferably, the modified base polymers are inserted at defined points into the shaping tool, optionally also fixed in order to ensure exact positioning.

The mould is then closed and filled with the foamable base polymer through the provided supply lines. The filling with the foamable base polymer preferably takes place after the mould has been closed, through injection points in the mould.

In process step c) it is possible to supply to the processing operation, preferably to a shaping tool, not just foamable base polymer that has not yet been prefoamed but also prefoamed but still foamable base polymer (prefoamed material).

The prefoamed base polymer is obtained from foamable base polymer by prefoaming processes known to those skilled in the art. Normally, some of the blowing agent, but not all of it, is activated for prefoaming by the supply of energy, preferably by increasing the temperature.

After prefoaming, the blowing agent content in the foamable base polymer is lower, but is still sufficient for foaming into the finished particle-foam component in the subsequent foaming process. The prefoamed material is supplied directly to process step c) or optionally deployed elsewhere. After prefoaming, condensation of the blowing agent during cooling gives rise to a negative pressure in the particles. If deployed elsewhere, the pressure can be equalized with the ambient pressure. In one particular embodiment, the foamable, optionally prefoamed, base polymer is introduced before the mould is closed.

### Process Step d):

In process step d) of the process of the invention, the processing temperature TP is set by the supply of energy.

Energy is supplied to the processing operation, more particularly to the mould, by means known to those skilled in the art. Heating normally occurs via the jacket heating of the mould. The base polymer, but also the modified base polymer, is here heated to a temperature TP that is above the glass transition temperature Tg of the foamable base polymer and the glass transition temperature Tg of the base polymer.

The processing temperature TP is above the prefoaming temperature.

Depending on the design of the mould support, the closed mould can also be pressurized. Pressures are usually between 0.5 bar and 10 bar, preferably between 3 bar and 8 bar.

### Process Step e):

In process step e) of the process of the invention, a material join between the foamed base polymer and the modified base polymer is created.

As a result of the temperature increase above the foaming temperature, the foamable, optionally prefoamed, base polymer is softened and foamed further. This brings about the material join with the modified base polymer (compact material).

Examples of methods include pressing processes (also referred to as compression moulding in the prior art) such as hot pressing, for example by electrical heating, by means of a heating medium or by induction, bonding, sintering using (supersaturated) steam, or using electromagnetic radiation such as radio waves and microwaves.

A variant of the process of the invention comprises the steam-treatment of the foamable, optionally prefoamed, base polymer in order to initiate the foaming process.

The duration of shaping depends primarily on the base material, the blowing agent present therein and the method used. Those skilled in the art can determine suitable processing times by means of routine tests or can take them from the prior art.

Process step e) is carried out at the processing temperature TP over a period of from a few seconds to several minutes, preferably between 1 sec and 3 h, more preferably between 5 sec and 60 min, most preferably between 10 sec and 10 min.

It is preferable that in process step e) the processing temperature TP is above or equal to the glass transition temperature of the modified base polymer Tg_{base polymer modified}.

By way of illustration, the following sequence can be assumed:

Tg_{foamable base polymer}≤Tg_{base polymer modified}≤TP (processing temperature)<Tg_{base polymer} (compact material).

### Process Step f)

In process step f) of the process of the invention, the single-component particle-foam component obtained is removed. For this, the mould is optionally cooled before it is opened. The single-material particle-foam component is removed manually or with a gripper.

After shaping, a cover layer or film is optionally applied to the single-material particle-foam component that is formed. Such cover layers and films and their methods of application are known to those skilled in the art.

### Optional Process Step g)

In the optional process step g), the single-material particle-foam component is heat-treated. The heat-treatment is recommended for high-value applications in which particular value is placed on dimensional stability.

Heat-treatment processes are known to those skilled in the art. The component is here heated slowly and steadily below the melting temperature or glass transition temperature over a period of several minutes to hours, depending on the type of material and the thickness.

The heat-treatment is typically carried out at temperatures in the range from 0 to 200° C., preferably 15 to 170° C., more preferably 80 to 150° C. Elevated temperatures and, if necessary, the application of a negative pressure (vacuum) can promote the outward diffusion of any residual propellant or residual moisture.

### Recycling-Optimized Single-Material Particle-Foam Components

In a further aspect, the present invention relates to a foam produced by the process of the invention, the single-material particle-foam component, which is particularly well suited for recycling processes. Surprisingly, it was found that a component is obtained that can be sent for high-value recycling.

The avoidance of foreign materials in the recyclate makes the single-component particle-foam components particularly suitable for high-value, single-product recycling.

The single-component particle-foam components obtained are generally closed-cell. They preferably have a density in the range from 20 to 250 kg/m³, more preferably in the range from 40 to 150 kg/m³, measured in accordance with DIN EN ISO 1183-1 (publication 2019-09).

By employing a modified base polymer that is used in the form of the unfoamed polymer, in combination with the correspondingly foamed polymer obtained from the same thermoplastic base material, a single-component particle-foam component is produced. This single-component system is suitable for upcycling, since it is not mixed with foreign materials and thus avoids the downgrading in properties that usually leads to downcycling. The modification of the base polymer is reversible since, with appropriate process control, the agent used for modification in process step b) can be removed leaving almost no residue. This means the thermomechanical properties and glass transition temperature of the base polymer can be achieved again almost completely.

In addition, it was found that the modification allows the processing temperature in process step d) to be lowered. This results in savings in energy costs and thus in a more profitable process.

The use of the single-material particle-foam components produced by the process according to one of the claims is broad in scope. In particular, the process is used in the aerospace industry, shipbuilding, wind power, in the sport and leisure sector and in vehicle construction, especially in electromobility.

Preference is given to using the single-material particle-foam components in lightweight construction, for example for the production of motor vehicle parts such as sun visors, column claddings, headliners, luggage compartment and spare wheel covers, engine hoods, underbodies or parcel shelves. General examples are in addition: semifinished products for the production of furniture (for example panels) and furniture itself, toys, outdoor objects, machine claddings and components and the like.

The present process and the single-material particle-foam components produced therewith are particularly suitable for high-temperature applications.

### EXAMPLES

### Example 1

### Production of a Single-Material Particle-Foam Component Based on Polyetherimide (PEI)

First, a foamable polyetherimide (base polymer) is provided.

Polyetherimide that had already been prefoamed was used.

In a second process step, a modified polyetherimide (modified base polymer) is provided. For this, a polyetherimide moulding in the form of a screw boss having a glass transition temperature of 217° C., measured by DSC in accordance with DIN EN ISO 11357-2 (published: 2014-07) is placed in an acetone bath heated to 50° C.

After 30 minutes, the surface of the polyetherimide screw boss has been modified through the absorption of acetone and close to the surface has a glass transition temperature Tg_{modified base polymer} of 150° C.

The modified screw boss (modified base polymer) is inserted in the shaping tool.

The shaping tool is then closed and filled with the foamable polyetherimide (base polymer), which has already been prefoamed. The processing temperature (TP) of 175° C. is set via the jacket heating of the shaping tool. A further supply of energy creates a material join between the foamed polyetherimide and the polyetherimide screw boss.

The polyetherimide-based single-material particle-foam component obtained was removed from the shaping tool.

The single-material particle-foam component had a firm material join between the insert (screw boss) and the polyetherimide foam.

### Example 2

### Production of a Recycling-Optimized Single-Material Particle-Foam Component

The single-component particle foam moulding made from polyetherimide that was produced in example 1 is heat-treated at 150° C. for 24 hours. The agent used for modification in example 1 (acetone) was removed almost completely. The residual acetone content was below the detection limit. The glass transition temperature of the recycling-optimized single-material particle-foam component was 217° C., measured by DSC in accordance with DIN EN ISO 11357-2 (published: 2014-07).

1. A process for producing a single-material particle-foam component based on thermoplastic base polymer, comprising: processing a foamable base polymer with a modified base polymer into a single-material particle-foam component,
wherein modification of the thermoplastic base polymer to produce the modified base polymer is effected by adding a solvent, blowing agent or plasticizer.

2. The process according to claim 1, wherein the process comprises:
a) providing a foamable base polymer, wherein the foamable base polymer has optionally already been prefoamed,
b) providing a modified base polymer,
c) supplying the modified base polymer to the processing operation and supplying the foamable base polymer, wherein the foamable base polymer has optionally already been prefoamed,
d) setting the processing temperature TP by the supply of energy and
e) creating a material join between the foamed base polymer and the modified base polymer,
f) removing the single-material particle-foam component obtained,
g) optionally, heat-treating the single-component particle-foam component obtained.

3. The process according to claim 1, wherein the modified base polymer has a glass transition temperature Tg_{base polymer modified} below the glass transition temperature of the base polymer Tg_{base polymer}, measured by DSC in accordance with DIN EN ISO 11357-2 (published: 2014-07).

4. The process according to claim 1, wherein the thermoplastic base polymer is selected from the group consisting of polyimide, polyketone and polyacrylate, polyethylene terephthalate (PET), polysulfone (PSU), polyethersulfone (PESU), polyphenylenesulfone (PPSU), and polyamide (PA) or mixtures thereof.

5. The process according to claim 1, wherein the solvent is at least one blowing agent selected from the group consisting of ketones, non-halogenated hydrocarbons, alcohols, urea, acetone, pentane, methyl ethyl ketone and methanol.

6. The process according to claim 1, wherein the modification of the thermoplastic base polymer to produce a modified base polymer is effected by spraying, dipping, wetting or mixing with a blowing agent, solvent or plasticizer.

7. The process according to claim 2, wherein in process d) the processing temperature TP is above the glass transition temperature Tg of the foamable base polymer.

8. The process according to claim 2, wherein in process e) the processing temperature TP is above or equal to the glass transition temperature of the modified base polymer Tg_{base polymer modified}.

9. The process according to claim 2, wherein in process c) the filling with the foamable base polymer takes place after a mould has been closed, through injection points in the mould.

10. The single-material particle-foam components produced by the process according to claim 1, wherein the components are utilized in at least one application selected from the group consisting of aerospace industry, shipbuilding, wind power, sport and leisure sector and vehicle construction.

11. Recycling-optimized single-material particle-foam components produced by the process according to claim 1, wherein the single-material particle-foam component consists of the thermoplastic base polymer and the agent used for modification, wherein the agent has been removed leaving substantially no residue.
